(19) United States
(12) Patent Application Publication
(10) Pub. No.: US 2021/0391950 A1
(43) Pub. Date: Dec. 16, 2021

(54) Methods and Apparatus for Cross-Layer Transport Awareness

(71) Applicant: Apple Inc., Cupertino, CA (US)

(72) Inventors: Christoph PAASCH, Cupertino, CA (US); Cayha Adiansyah MASPUTRA, San Jose, CA (US)

(73) Assignee: Apple Inc., Cupertino, CA (US)

(21) Appl. No.: 17/346,123

(22) Filed: Jun. 11, 2021

Related U.S. Application Data
(60) Provisional application No. 63/038,473, filed on Jun. 12, 2020.

(51) Int. Cl. H04L 1/16; H04L 12/861; H04L 29/06

(52) U.S. Cl. CPC H04L 1/1607; H04L 69/16; H04L 49/90

(57) ABSTRACT

Techniques are provided for managing cross-layer transport awareness of a user space protocol stack. A protocol layer of a user space protocol stack within a user space application operated in a user space of a first device can receive a batch of packets of a data flow from a corresponding protocol layer operated by a second device. The protocol layer can process a group of packets in the batch of packets to generate a set of acknowledgement packets of the data flow, and process an additional packet in the batch of packets to generate an additional acknowledgement packet of the data flow. The additional acknowledgement packet is indicated to supersede the set of acknowledgement packets. The protocol layer can transmit the additional acknowledgement packet to the second device to indicate that both the group of packets and the additional packet have been received by the first device.

### CROSS-REFERENCE TO RELATED APPLICATIONS

This application claims priority to U.S. Provisional Patent Application No. 63/038,473, filed Jun. 12, 2020, which is hereby incorporated by reference in its entirety.

This application is related to the subject matter of U.S. Provisional Patent Application Ser. No. 63/038,520 filed on Jun. 12, 2020 and entitled “Methods and Apparatus for Flow-Based Batching and Processing,” which is incorporated herein by reference in its entirety.

This application incorporates by reference the subject matter of the following: U.S. patent application Ser. No. 16/144,992 filed Sep. 27, 2018, now pending, and entitled “Methods and Apparatus for Single Entity Buffer Pool Management”, U.S. patent application Ser. No. 16/146,533 filed Sep. 28, 2018, now pending, and entitled “Methods and Apparatus for Regulating Networking Traffic in Bursty System Conditions”, U.S. patent application Ser. No. 16/146,324 filed Sep. 28, 2018, now U.S. Pat. No. 10,978,224 and entitled “Methods and Apparatus for Preventing Packet Spoofing with User Space Communication Stacks”, U.S. patent application Ser. No. 16/146,916 filed Sep. 28, 2018, now U.S. Pat. No. 10,819,831 and entitled “Methods and Apparatus for Channel Defunct Within User Space Stack Architectures”, U.S. patent application Ser. No. 16/236,032 filed Dec. 28, 2018, now pending and entitled “Methods and Apparatus for Classification of Flow Metadata with User Space Communication Stacks”, U.S. patent application Ser. No. 16/363,495 filed Mar. 25, 2019, now pending and entitled “Methods and Apparatus for Dynamic Packet Pool Configuration in Networking Stack Infrastructures”, U.S. patent application Ser. No. 16/365,462 filed on Mar. 26, 2019, now pending and entitled “Methods and Apparatus for Sharing and Arbitration of Host Stack Information with User Space Communication Stacks”, U.S. patent application Ser. No. 16/368,338, now pending, filed on Mar. 28, 2019 and entitled “Methods and Apparatus for Memory Allocation and Reallocation in Networking Stack Infrastructures”, U.S. patent application Ser. No. 16/365,484, filed on Mar. 26, 2019, now pending and entitled “Methods and Apparatus for Virtualized Hardware Optimizations for User Space Networking”, U.S. patent application Ser. No. 16/368,368 filed on Mar. 28, 2019, now pending, and entitled “Methods and Apparatus for Active Queue Management in User Space Networking”, and U.S. patent application Ser. No. 16/368,214 filed on Mar. 28, 2019, now pending and entitled “Methods and Apparatus for Self-Tuning Operation with User Space Stack Architectures”, U.S. Provisional Patent Application Ser. No. 62/906,617 filed Sep. 26, 2019 and entitled “Methods and Apparatus for Low Latency Operation in User Space Networking”, U.S. Provisional Patent Application Ser. No. 62/906,645 filed Sep. 26, 2019 and entitled “Methods and Apparatus for Emerging Use Case Support in User Space Networking”, and U.S. Provisional Patent Application Ser. No. 62/906,657 filed Sep. 26, 2019 and entitled “Methods and Apparatus for Device Driver Operation in Non-Kernel Space”, the contents of an each of the foregoing being incorporated herein by reference in their entireties.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

The disclosure relates generally to the field of electronic devices, as well as networks thereof. More particularly, the disclosure is directed to methods and apparatus for implementing computerized networking stack infrastructures.

### DESCRIPTION OF RELATED TECHNOLOGY

The consumer electronics industry has seen explosive growth in network connectivity; for example, Internet connectivity is now virtually ubiquitous across many different device types for a variety of different applications and functionalities. The successful implementation of network connectivity over a myriad of different usage cases has been enabled by, inter alia, the principles of modular design and abstraction. Specifically, the traditional network communication paradigm incorporates multiple (generally) modular software “layers” into a “communication stack.” Each layer of the communication stack separately manages its own implementation specific considerations and provides an “abstracted” communication interface to the next layer. In this manner, different applications can communicate freely across different devices without considering the underlying network transport.

As but one such example, the Transmission Control Protocol/Internet Protocol (TCP/IP) suite provides reliable, ordered, and error-checked data transfer between network endpoints. A user application does not need to know the particular mechanisms for sending data; instead, the user application reads and writes data via a network socket interface to the TCP/IP suite. The TCP/IP suite packetizes the data and sends packets to the endpoint via a data link layer connection. Similarly, the data link layer operates at a level of abstraction below the TCP/IP suite. The data link layer manages data transfer to the next node in the network; data packets are often relayed across many intermediary nodes between network endpoints.

Modern device constructions and/or use cases aggressively push the boundaries of performance. For example, batch processing reduces latency but increases processing and/or memory throughput. Under some circumstances, generic communication protocols may incorrectly attribute such latency to underlying network conditions. As a result, batch processing may trigger inappropriate network responses (e.g., unnecessary retransmissions, bandwidth throttling, etc.)

### SUMMARY

The present disclosure satisfies the foregoing needs by providing, inter alia, methods and apparatus for cross-layer transport awareness.

In one aspect, methods and apparatus configured to coordinate acknowledgement signaling are disclosed. A method can include receiving, by a protocol layer of a user space protocol stack within a user space application operated in a user space of a first device, a batch of packets of a data flow from a corresponding protocol layer operated by a second device; processing a group of packets in the batch of packets to generate a set of acknowledgement packets of the data flow, and processing an additional packet in the batch of packets to generate an additional acknowledgement packet of the data flow, wherein the additional acknowledgement packet is indicated to supersede the set of acknowledgement packets; and transmitting the additional acknowledgement packet to the second device to indicate that both the group of packets and the additional packet have been received by the first device.

In one aspect, methods and apparatus for suppressing acknowledgement signaling based on flow-specific information are disclosed. A system configured for managing packet flows can include a storage device; and a processor coupled to the storage device. The processor can be configured to receive, by a protocol layer of a user space protocol stack within a user space application operated in a user space of a first device, a batch of packets of a data flow from a corresponding protocol layer operated by a second device; process a group of packets in the batch of packets to generate a set of acknowledgement packets of the data flow, and process an additional packet in the batch of packets to generate an additional acknowledgement packet of the data flow, wherein the additional acknowledgement packet is indicated to supersede the set of acknowledgement packets; and transmit the additional acknowledgement packet to the second device to indicate that both the first group of packets and the additional packet have been received by the first device.

In another aspect, a non-transitory computer readable storage apparatus implementing one or more of the aspects disclosed herein is disclosed and described. A non-transitory computer readable medium comprising computer instructions stored thereon, the computer programs being configured to, when executed by a processor, can cause a computerized apparatus to: receive, by a protocol layer of a user space protocol stack within a user space application operated in a user space of a first device, a batch of packets of a data flow from a corresponding protocol layer operated by a second device; process a group of packets in the batch of packets to generate a set of acknowledgement packets of the data flow, and process an additional packet in the batch of packets to generate an additional acknowledgement packet of the data flow, wherein the additional acknowledgement packet is indicated to supersede the set of acknowledgement packets; and transmit the additional acknowledgement packet to the second device to indicate that both the first group of packets and the additional packet have been received by the first device.

In one aspect, methods and apparatus for suppressing acknowledgement signaling based on cross-layer indications provided from a peer device.

In another aspect, computerized apparatus implementing one or more of the foregoing methods and/or apparatus are disclosed.

In one embodiment, the computerized apparatus comprises a personal computer, such as a desktop computer.

In another embodiment, the computerized apparatus comprises a mobile device such as a smartphone or tablet computer, or laptop computer.

In yet another embodiment, the computerized apparatus comprises a server or server blade.

In still another embodiment, the computerized apparatus comprises a GPU-based architecture optimized for deep learning or machine-learning.

In still another embodiment, the computerized apparatus comprises a media player or rendering device, such as a portable player.

In still another embodiment, the computerized apparatus comprises a host server or similar device, with hypervisor and configured to support multiple “guest” virtual machines (VMs) and/or containerized applications.

In another aspect, an integrated circuit (IC) device implementing one or more of the foregoing aspects is disclosed and described. In one embodiment, the IC device is embodied as a SoC (system on Chip) device. In another embodiment, an ASIC (application specific IC) is used as the basis of the device. In yet another embodiment, a chip set (i.e., multiple ICs used in coordinated fashion) is disclosed. In yet another embodiment, the device comprises a multi-logic block FPGA device. In a further embodiment, the IC device is a modem or modem chipset. In another embodiment, the IC device comprises a multi-core processor architecture.

In another aspect, a computer readable storage apparatus implementing one or more of the foregoing aspects is disclosed and described. In one embodiment, the computer readable apparatus comprises a program memory, or an EEPROM. In another embodiment, the apparatus includes a solid state drive (SSD) or other mass storage device. In another embodiment, the apparatus comprises a USB or other “flash drive” or other such portable removable storage device. In yet another embodiment, the apparatus comprises a “cloud” (network) based storage device which is remote from yet accessible via a computerized user or client electronic device. As another embodiment, the storage device is part of a server “farm” or “big data” compute environment.

In yet another aspect, an operating system (OS) is disclosed. In one embodiment, the OS includes a user space and kernel space. In another embodiment, the OS is open-source (e.g., Linux)-based. In another embodiment, the OS is non-open (e.g., proprietary) based.

Other features and advantages of the present disclosure will immediately be recognized by persons of ordinary skill in the art with reference to the attached drawings and detailed description of exemplary embodiments as given below.

### BRIEF DESCRIPTION OF THE DRAWINGS

FIG. 1 is a logical representation of a traditional network socket, useful for explaining various aspects of the present disclosure.

FIG. 2 is a logical representation of a computer system that implements Input/Output (I/O) network control, useful for explaining various aspects of the present disclosure.

FIG. 3 is a logical block diagram of one exemplary implementation of Transport Layer Security (TLS), useful for explaining various aspects of the present disclosure.

FIG. 4 is a logical block diagram of an exemplary implementation of a Virtual Private Network (VPN), useful for explaining various aspects of the present disclosure.

FIG. 5 illustrates a logical block diagram of an exemplary implementation of application-based tuning, useful to explain various other workload optimization complexities of emerging use cases.

FIG. 6 illustrates one logical representation of an exemplary user space networking stack architecture, in accordance with the various aspects of the present disclosure.

FIG. 7 is a logical block diagram of one logical block diagram of an exemplary user space networking stack, in accordance with the various aspects of the present disclosure.

FIG. 8 is a logical block diagram of the Transmission Control Protocol (TCP) acknowledgement and retransmission procedure, useful to illustrate various aspects of the present disclosure.

FIG. 8 is a logical block diagram of the Transmission Control Protocol (TCP) acknowledgement and retransmission procedure, useful to illustrate various aspects of the present disclosure.

FIG. 9 is a logical block diagram of an exemplary system that implements batch processing in conjunction with the aforementioned Transmission Control Protocol (TCP) procedure, useful to illustrate various aspects of the present disclosure.

FIG. 10 is a logical block diagram of an exemplary system that implements cross-layer awareness in conjunction with batch processing, in accordance with the various principles described herein.

FIG. 11 is a logical ladder diagram representation of one exemplary Transmission Control Protocol (TCP) Acknowledgement (ACK) suppression scheme, in accordance with the various principles described herein.

FIG. 12 is a graphical representation of network performance, useful to illustrate the various advantages of the present disclosure.

FIG. 13 is a logical block diagram of a network of devices useful to describe pass through cross-layer signaling, in accordance with various aspects of the present disclosure.

FIG. 14 is a logical diagram representation of one exemplary acknowledgement suppression scheme, in accordance with the various embodiments described herein.

FIG. 15 is an example computer system useful for implementing various embodiments.

All figures © Copyright 2017-2021 Apple Inc. All rights reserved.

### DETAILED DESCRIPTION

Reference is now made to the drawings, wherein like numerals refer to like parts throughout.

### DETAILED DESCRIPTION OF EXEMPLARY EMBODIMENTS

### Existing Network Socket Technologies

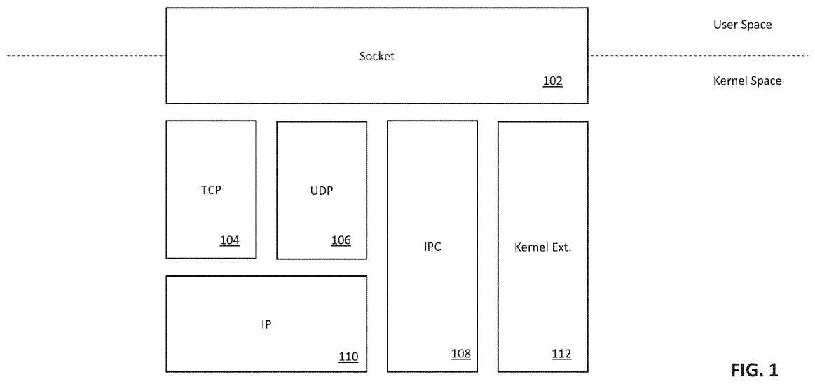

FIG. 1 illustrates one logical representation of a traditional network socket 102, useful for explaining various aspects of the traditional networking interface. A network “socket” is a virtualized internal network endpoint for sending or receiving data at a single node in a computer network. A network socket may be created (“opened”) or destroyed (“closed”) and the manifest of network sockets may be stored as entries in a network resource table which may additionally include reference to various communication protocols (e.g., Transmission Control Protocol (TCP) 104, User Datagram Protocol (UDP) 106, Inter-Processor Communication (IPC) 108, etc.), destination, status, and any other operational processes (kernel extensions 112) and/or parameters); more generally, network sockets are a form of system resource.

As shown in FIG. 1, the socket 102 provides an application programming interface (API) that spans between the user space and the kernel space. An API is a set of clearly defined methods of communication between various software components. An API specification commonly includes, without limitation: routines, data structures, object classes, variables, remote calls and/or any number of other software constructs commonly defined within the computing arts.

As a brief aside, user space is a portion of system memory that a processor executes user processes from. User space is relatively freely and dynamically allocated for application software and a few device drivers. The kernel space is a portion of memory that a processor executes the kernel from. Kernel space is strictly reserved (usually during the processor boot sequence) for running privileged operating system (O/S) processes, extensions, and most device drivers. For example, each user space process normally runs in a specific memory space (its own “sandbox”) and cannot access the memory of other processes unless explicitly allowed. In contrast, the kernel is the core of a computer's operating system; the kernel can exert complete control over all other processes in the system.

The term “operating system” may refer to software that controls and manages access to hardware. An O/S commonly supports processing functions such as e.g., task scheduling, application execution, input and output management, memory management, security, and peripheral access. As used herein, the term “application” refers to software that can interact with the hardware only via procedures and interfaces offered by the O/S.

The term “privilege” may refer to any access restriction or permission which restricts or permits processor execution. System privileges are commonly used within the computing arts to, inter alia, mitigate the potential damage of a computer security vulnerability. For instance, a properly privileged computer system will prevent malicious software applications from affecting data and task execution associated with other applications and the kernel.

As used herein, the term “in-kernel” and/or “kernel space” may refer to data and/or processes that are stored in, and/or have privilege to access the kernel space memory allocations. In contrast, the terms “non-kernel” and/or “user space” refers to data and/or processes that are not privileged to access the kernel space memory allocations. In particular, user space represents the address space specific to the user process, whereas non-kernel space represents address space which is not in-kernel, but which may or may not be specific to user processes.

As previously noted, the illustrated socket 102 provides access to Transmission Control Protocol (TCP) 104, User Datagram Protocol (UDP) 106, and Inter-Processor Communication (IPC) 108. TCP, UDP, and IPC are various suites of transmission protocols each offering different capabilities and/or functionalities. For example, UDP is a minimal message-oriented encapsulation protocol that provides no guarantees to the upper layer protocol for message delivery and the UDP layer retains no state of UDP messages once sent. UDP is commonly used for real-time, interactive applications (e.g., video chat, voice over IP (VoIP)) where loss of packets is acceptable. In contrast, TCP provides reliable, ordered, and error-checked delivery of data via a retransmission and acknowledgement scheme; TCP is generally used for file transfers where packet loss is unacceptable, and transmission latency is flexible.

As used herein, the term “encapsulation protocol” may refer to modular communication protocols in which logically separate functions in the network are abstracted from their underlying structures by inclusion or information hiding within higher level objects. For example, in one exemplary embodiment, UDP provides extra information (ports numbering).

As used herein, the term “transport protocol” may refer to communication protocols that transport data between logical endpoints. A transport protocol may include encapsulation protocol functionality.

Both TCP and UDP are commonly layered over an Internet Protocol (IP) 110 for transmission. IP is a connectionless protocol for use on packet-switched networks that provides a “best effort delivery”. Best effort delivery does not guarantee delivery, nor does it assure proper sequencing or avoidance of duplicate delivery. Generally these aspects are addressed by TCP or another transport protocol based on UDP.

As a brief aside, consider a web browser that opens a webpage; the web browser application would generally open a number of network sockets to download and/or interact with the various digital assets of the webpage (e.g., for a relatively common place webpage, this could entail instantiating ˜300 sockets). The web browser can write (or read) data to the socket; thereafter, the socket object executes system calls within kernel space to copy (or fetch) data to data structures in the kernel space.

As used herein, the term “domain” may refer to a self-contained memory allocation e.g., user space, kernel space. A “domain crossing” may refer to a transaction, event, or process that “crosses” from one domain to another domain. For example, writing to a network socket from the user space to the kernel space constitutes a domain crossing access.

In the context of a Berkeley Software Distribution (BSD) based networking implementation, data that is transacted within the kernel space is stored in memory buffers that are also commonly referred to as “mbufs”. Each mbuf is a fixed size memory buffer that is used generically for transfers (mbufs are used regardless of the calling process e.g., TCP, UDP, etc.). Arbitrarily sized data can be split into multiple mbufs and retrieved one at a time or (depending on system support) retrieved using “scatter-gather” direct memory access (DMA) (“scatter-gather” refers to the process of gathering data from, or scattering data into, a given set of buffers). Each mbuf transfer is parameterized by a single identified mbuf.

Notably, each socket transfer can create multiple mbuf transfers, where each mbuf transfer copies (or fetches) data from a single mbuf at a time. As a further complication, because the socket spans both: (i) user space (limited privileges) and (ii) kernel space (privileged without limitation), the socket transfer verifies that each mbuf copy into/out of kernel space is valid. More directly, the verification process ensures that the data access is not malicious, corrupted, and/or malformed (i.e., that the transfer is appropriately sized and is to/from an appropriate area).

The processing overhead associated with domain crossing is a non-trivial processing cost. Processing cost affects user experience both directly and indirectly. A processor has a fixed amount of processing cycles every second; thus cycles that are used for transfer verification detract from more user perceptible tasks (e.g., rendering a video or audio stream). Additionally, processor activity consumes power; thus, increases in processing overhead increases power consumption.

Referring back to FIG. 1, in addition to the generic TCP 104, UDP 106, and IPC 108 communication suites, the illustrated socket 102 also may provide access to various kernel extensions 112. A kernel extension is a dynamically loaded bundle of executable code that executes from kernel space. Kernel extensions may be used to perform low-level tasks that cannot be performed in user space. These low-level tasks typically fall into one or more of: low-level device drivers, network filters, and/or file systems. Examples of sockets and/or extensions include without limitation: route (IP route handling), ndrv (packet 802.1X handling), key (key management), unix (translations for Unix systems), kernel control, kernel events, parental controls, intrusion detection, content filtering, hypervisors, and/or any number of other kernel tasking.

Kernel extensions and public APIs enable, for example, 3^{rd} party software developers to develop a wide variety of applications that can interact with a computer system at even the lowest layers of abstraction. For example, kernel extensions can enable socket level filtering, IP level filtering, and even device interface filtering. In the current consumer applications space, many emerging technologies now rely on closely coupled interfaces to the hardware and kernel functionality. For example, many security applications “sniff” network traffic to detect malicious traffic or filter undesirable content; this requires access to other application sandboxes (a level of privilege that is normally reserved for the kernel).

Unfortunately, 3^{rd} party kernel extensions can be dangerous and/or undesirable. As previously noted, software applications are restricted for security and stability reasons; however the kernel is largely unrestricted. A 3^{rd} party kernel extension can introduce instability issues because the 3rd party kernel extensions run in the same address space as the kernel itself (which is outside the purview of traditional memory read/write protections based on memory allocations). Illegal memory accesses can result in segmentation faults and memory corruptions. Furthermore, unsecure kernel extension can create security vulnerabilities that can be exploited by malware. Additionally, even where correctly used, a kernel extension can expose a user's data to the 3^{rd} party software developer. This heightened level of access may raise privacy concerns (e.g., the 3^{rd} party developer may have access to browsing habits, etc.).

### Existing Performance Optimization Technologies

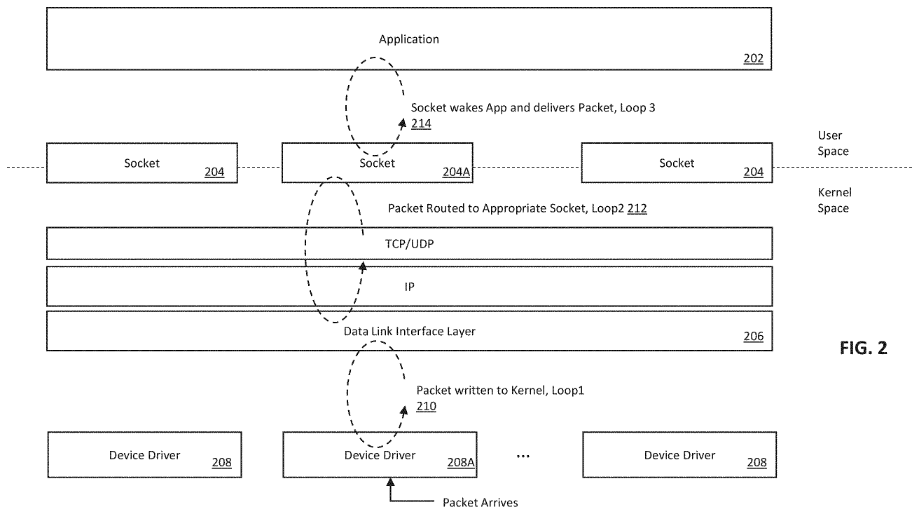

FIG. 2 illustrates one logical representation of a computer system that implements Input/Output (I/O) network control, useful for explaining various aspects of traditional network optimization. As depicted therein, a software application 202 executing from user space opens multiple sockets 204 to communicate with e.g., a web server. Each of the sockets interfaces with a Data Link Interface Layer (DLIL) 206.

The DLIL 206 provides a common interface layer to each of the various physical device drivers which will handle the subsequent data transfer (e.g., Ethernet, Wi-Fi, cellular, etc.). The DLIL performs a number of system-wide holistic network traffic management functions. In one such implementation, the DLIL is responsible for BSD Virtual Interfaces, IOKit Interfaces (e.g., DLIL is the entity by which IOKit based network drivers are connected to the networking stack), Active Queue Management (AQM), flow control and advisory action, etc. In most cases, the device driver 208 may be handled by an external device (e.g., a baseband co-processor), thus the DLIL 206 is usually (but not always) the lowest layer of the network communication stack.

During normal operation, the computer system will logically segment its tasks to optimize overall system operation. In particular, a processor will execute a task, and then “context switch” to another task, thereby ensuring that any single process thread does not monopolize processor resources from start to finish. More directly, a context switch is the process of storing the state of a process, or of a thread, so that it can be restored and execution resumed from the same point later. This allows multiple processes to share a single processor. However, excessive amounts of context switching can slow processor performance down. Notably, while the present discussion is primarily discussed within the context of a single processor for ease of understanding, multi-processor systems have analogous concepts (e.g., multiple processors also perform context switching, although contexts may not necessarily be resumed by the same processor).

For example, consider the following example of a packet reception. Packets arrive at the device driver 208A. The hardware managed by the device driver 208A may notify the processor via e.g., a doorbell signal (e.g., an interrupt). The device driver 208A work loop thread handles the hardware interrupt/doorbell, then signals the DLIL thread (Loop 1 210). The processor services the device driver 208A with high priority, thereby ensuring that the device driver 208A operation is not bottlenecked (e.g., that the data does not overflow the device driver's memory and/or that the device driver does not stall). Once the data has been moved out of the device driver, the processor can context switch to other tasks.

At a later point, the processor can pick up the DLIL 206 execution process again. The processor determines which socket the packets should be routed to (e.g., socket 204A) and routes the packet data appropriately (Loop 2 212). During this loop, the DLIL thread takes each packet, and moves each one sequentially into the socket memory space. Again, the processor can context switch to other tasks so as to ensure that the DLIL task does not block other concurrently executed processing.

Subsequently thereafter, when the socket has the complete packet data transfer the processor can wake the user space application and deliver the packet into user space memory (Loop 3 214). Generally, user space applications are treated at lower priority than kernel tasks; this can be reflected by larger time intervals between suspension and resumption. While the foregoing discussion is presented in the context of packet reception, artisans of ordinary skill in the related arts will readily appreciate, given the contents of the present disclosure, that the process is substantially reversed for packet transmission.

As demonstrated in the foregoing example, context switching ensures that tasks of different processing priority are allocated commensurate amounts of processing time. For example, a processor can spend significantly more time executing tasks of relatively high priority, and service lower priority tasks on an as-needed basis. As a brief aside, human perception is much more forgiving than hardware operation. Consequently, kernel tasks are generally performed at a much higher priority than user space applications. The difference in priority between kernel and user space allows the kernel to handle immediate system management (e.g., hardware interrupts, and queue overflow) in a timely manner, with minimal noticeable impact to the user experience.

Moreover, FIG. 2 is substantially representative of every implementation of the traditional network communications stack. While implementations may vary from this illustrative example, virtually all networking stacks share substantially the same delivery mechanism. The traditional network communications stack schema (such as the BSD architecture and derivatives therefrom) have been very popular for the past 30 years due to its relative stability of implementation and versatility across many different device platforms. For example, the Assignee hereof has developed and implemented the same networking stack across virtually all of its products (e.g., MacBook®, iMac®, iPad®, and iPhone®, Apple Watch®, etc.).

Unfortunately, changing tastes in consumer expectations cannot be effectively addressed with the one-size-fits-all model and the conservative in-kernel traditional networking stack. Artisans of ordinary skill in the related arts will readily appreciate, given the contents of the present disclosure, that different device platforms have different capabilities; for example, a desktop processor has significantly more processing and memory capability than a mobile phone processor. More directly, the “one-size-fits-all” solution does not account for the underlying platform capabilities and/or application requirements, and thus is not optimized for performance. Fine-tuning the traditional networking stack for performance based on various “tailored” special cases results in an inordinate amount of software complexity which is untenable to support across the entire ecosystem of devices.

### Emerging Use Cases

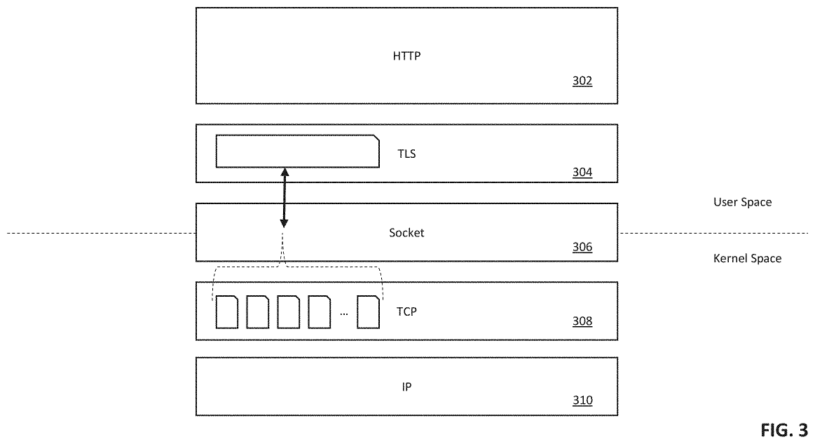

FIG. 3 illustrates a logical block diagram of one exemplary implementation of Transport Layer Security (TLS) (the successor to Secure Sockets Layer (SSL)), useful to explain user/kernel space integration complexities of emerging use cases.

As shown, an application executing from user space can open a Hypertext Transfer Protocol (HTTP) session 302 with a TLS security layer 304 in order to securely transfer data (Application Transport Security (ATS) services) over a network socket 306 that offers TCP/IP transport 308, 310.

As a brief aside, TLS is a record based protocol; in other words, TLS uses data records which are arbitrarily sized (e.g., up to 16 kilobytes). In contrast, TCP is a byte stream protocol (i.e., a byte has a fixed length of eight (8) bits). Consequently, the TCP layer subdivides TLS records into a sequentially ordered set of bytes for delivery. The receiver of the TCP byte stream reconstructs TLS records from the TCP byte stream by receiving each TCP packet, re-ordering the packets according to sequential numbering to recreate the byte stream and extracting the TLS record from the aggregated byte stream. Notably, every TCP packet of the sequence must be present before the TLS record can be reconstructed. Even though TCP can provide reliable delivery under lossy network conditions, there are a number of situations where TLS record delivery could fail. For example, under ideal conditions TCP isolates packet loss from its client (TLS in this example), and a single TCP packet loss should not result in failed TLS record delivery. However, the TLS layer or the application above may incorporate a timeout strategy in a manner that is unaware of the underlying TCP conditions. Thus, if there's significant packet loss in the network, the TLS timeout may be hit (and thus result in a failure to the application) even though TCP would normally provide reliable delivery.

Referring back to FIG. 3, virtually every modern operating system executes TLS from user space when e.g., securely connecting to other network entities, inter alia, a web browser instance and a server. But existing implementations of TLS are not executed from the kernel (or other privileged software layer) due to e.g., the complexity of error handling within the kernel. However, as a practical matter, TLS would operate significantly better with information regarding the current networking conditions (held in the kernel).

Ideally, the TLS layer should set TLS record sizes based on network condition information. In particular, large TLS records can efficiently use network bandwidth, but require many successful TCP packet deliveries. In contrast, small TLS records incur significantly more network overhead, but can survive poor bandwidth conditions. Unfortunately, networking condition information is lower layer information that is available to the kernel space (e.g., the DLIL and device drivers), but generally restricted from user space applications. Some 3^{rd} party application developers and device manufacturers have incorporated kernel extensions (or similar operating system capabilities) to provide network condition information to the TLS user space applications; however, kernel extensions are undesirable due to the aforementioned security and privacy concerns. Alternately, some 3^{rd} party applications infer the presence of lossy network conditions based on historic TLS record loss. Such inferences are an indirect measure and significantly less accurate and lag behind real-time information (i.e., previous packet loss often does not predict future packet loss).

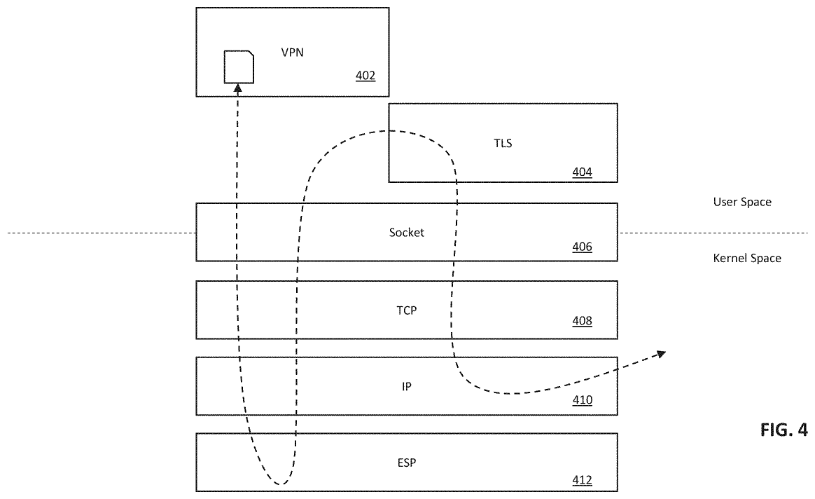

FIG. 4 illustrates a logical block diagram of an exemplary implementation of a Virtual Private Network (VPN), useful to explain recursive/cross-layer protocol layer complexities of emerging use cases.

As shown, an application executing from user space can open a Virtual Private Network (VPN) session 402 over a network socket 406 that offers TCP/IP transport 408, 410. The VPN session is secured with Encapsulating Security Protocol (ESP) 412. The encrypted packet is securely tunneled via TLS 404 (in user space) and recursively sent again over TCP/IP transport 408, 410.

As illustrated within FIG. 4, the exemplary VPN tunnel starts in user space, crosses into kernel space, returns back to user space, and then crosses back into kernel space before being transferred. Each of the domain crossings results in costly context switches and data shuffling both of which are processor intensive and inefficient. More directly, every time data traverses from user space to kernel space, the data must be validated (which takes non-trivial processing time). Additionally, context switching can introduce significant latency while the task is suspended.

Artisans of ordinary skill in the related arts, given the contents of the present disclosure, will readily appreciate that the exemplary recursive cross layer transaction of FIG. 4 is merely illustrative of a broad range of applications which use increasingly exotic protocol layer compositions. For example, applications that traverse the application proxy/agent data path commonly require tunneling TCP (kernel space) over application proxy/agent data path (user space) over UDP/IP (kernel space). Another common implementation is IP (kernel space) over Quick UDP Internet Connections (QUIC) (user space) over UDP/IP (kernel space).

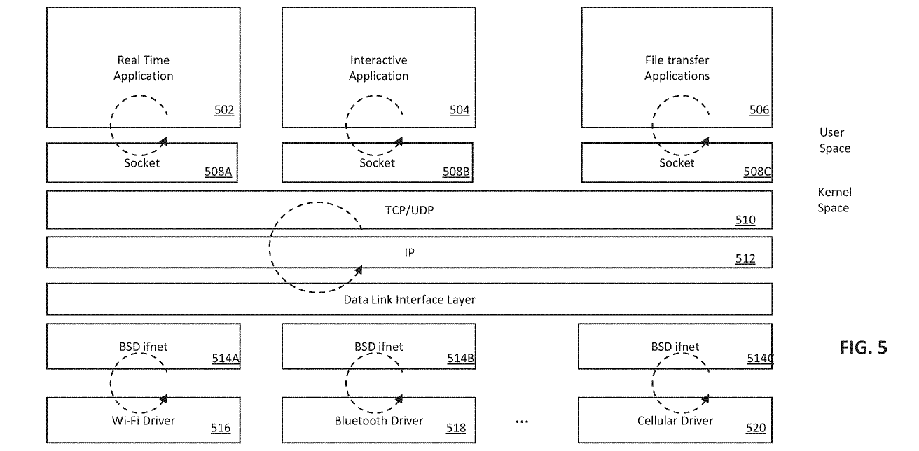

FIG. 5 illustrates a logical block diagram of an exemplary implementation of application-based tuning, useful to explain various other workload optimization complexities of emerging use cases.

As shown, three (3) different concurrently executed applications (e.g., a real time application 502, interactive application 504, and file transfer applications 506) in user space, each open a session over network sockets 508 (508A, 508B, 508C) that offer TCP/UDP/IP transport 510/512. Depending on the type of physical interface required, the sessions are switched to BSD network interfaces (ifnet) 514 (514A, 514B, 514C) which handle the appropriate technology. Three different illustrated technology drivers are shown: Wi-Fi 516, Bluetooth 518, and cellular 520.

It is well understood within the networking arts that different application types are associated with different capabilities and requirements. One such example is real time applications 502, commonly used for e.g., streaming audio/visual and/or other “live” data. Real time data has significant latency and/or throughput restrictions; moreover, certain real time applications may not require (and/or support) retransmission for reliable delivery of lost or corrupted data. Instead, real time applications may lower bandwidth requirements to compensate for poor transmission quality (resulting in lower quality, but timely, delivered data).

Another such example is interactive applications 504, commonly used for e.g., human input/output. Interactive data should be delivered at latencies that are below the human perceptible threshold (within several milliseconds) to ensure that the human experience is relatively seamless. This latency interval may be long enough for a retransmission, depending on the underlying physical technology. Additionally, human perception can be more or less tolerant of certain types of data corruptions; for example, audio delays below 20 ms are generally imperceptible, whereas audio corruptions (pops and clicks) are noticeable. Consequently, some interactive applications may allow for some level of error correction and/or adopt less aggressive bandwidth management mechanisms depending on the acceptable performance requirements for human perception.

In contrast to real time applications and interactive applications, file transfer applications 506 require perfect data fidelity without latency restrictions. To these ends, most file transfer technologies support retransmission of lost or corrupted data, and retransmission can have relatively long attempt intervals (e.g., on the order of multiple seconds to a minute).

Similarly, within the communication arts, different communication technologies are associated with different capabilities and requirements. For example, Wi-Fi 516 (wireless local area networking based on IEEE 802.11) is heavily based on contention-based access and is best suited for high bandwidth deliveries with reasonable latency. Wi-Fi is commonly used for file transfer type applications. Bluetooth 518 (personal area networking) is commonly used for low data rate and low latency applications. Bluetooth is commonly used for human interface devices (e.g., headphones, keyboards, and mice). Cellular network technologies 520 often provide non-contention-based access (e.g., dedicated user access) and can be used over varying geographic ranges. Cellular voice or video delivery is a good example of streaming data applications. Artisans of ordinary skill in the related arts will readily recognize that the foregoing examples are purely illustrative, and that different communication technologies are often used to support a variety of different types of application data. For example, Wi-Fi 516 can support file transfer, real time data transmission and/or interactive data with equivalent success.

Referring back to FIG. 5, the presence of multiple concurrently executing applications of FIG. 5 (real time application 502, interactive application 504, and file transfer applications 506) illustrates the complexities of multi-threaded operation. As shown therein, the exemplary multi-threaded operation incurs a number of server loops. Each server loop represents a logical break in the process during which the processor can context switch (see also aforementioned discussion of Existing Performance Optimization Technologies, and corresponding FIG. 2).

Moreover, in the computing arts, a “locking” synchronization mechanism is used by the kernel to enforce access limits (e.g., mutual exclusion) on resources in multi-threaded execution. During operation, each thread acquires a lock before accessing the corresponding locked resources data. In other words, at any point in time, the processor is necessarily limited to only the resources available to its currently executing process thread.

Unfortunately, each of the applications has different latency, throughput and processing utilization requirements. Since, each of the network interfaces is sending and receiving data at different times, in different amounts, and with different levels of priority. From a purely logistical standpoint, the kernel is constantly juggling between high priority kernel threads (to ensure that the high priority hardware activities do not stall out) while still servicing each of its concurrently running applications to attempt to provide acceptable levels of service. In some cases, however, the kernel is bottlenecked by the processor's capabilities. Under such situations, some threads will be deprioritized; currently, the traditional networking stack architecture is unable it clearly identify which threads can be deprioritized while still providing acceptable user service.

For example, consider an “expected use” device of FIG. 5; the processor is designed for the expected use case of providing streaming video. Designing for expected use cases allows the device manufacturer to use less capable, but adequate components thereby reducing bill of materials (BOM) costs and/or offering features at a reasonable price point for consumers. In this case, a processor is selected that nominally meets the requirements for a streaming video application that is receiving streaming video data via one of the network interfaces (e.g., the Wi-Fi interface), and constantly servicing the kernel threads associated with it. Rendering the video with a real time application 502 from the received data is a user space application that is executed concurrently but at a significantly lower priority. During expected usage, the video rendering is adequate.

Unfortunately, the addition of an unexpected amount of additional secondary interactive applications 504 (e.g., remote control interface, headphones, and/or other interface devices) and/or background file transfer applications can easily overwhelm the processor. Specifically, the primary real time application does not get enough CPU cycles to run within its time budget, because the kernel threads handling networking are selected at a higher priority. In other words, the user space application is not able to depress the priority of kernel networking threads (which are servicing both the primary and secondary processes). This can result in significantly worse user experience when the video rendering stalls out (video frame misses or video frame drops); whereas simply slowing down a file transfer or degrading the interaction interface may have been preferable.

Prior art solutions have tailored software for specific device implementations (e.g., the Apple TV®). For example, the device can be specifically programmed for an expected use. However, tailored solutions are becoming increasingly common and by extension the exceptions have swallowed the more generic use case. Moreover, tailored solutions are undesirable from multiple software maintenance standpoints. Devices have limited productive lifetimes, and software upkeep is non-trivial.

Ideally, a per-application or per-profile workload optimization would enable a single processor (or multiple processors) to intelligently determine when and/or how too intelligently context switch and/or prioritize its application load (e.g., in the example of FIG. 5, to prioritize video decode). Unfortunately, such solutions are not feasible within the context of the existing generic network sockets and generic network interfaces to a monolithic communications stack.

### Exemplary User Space Networking Architecture

A networking stack architecture and technology that caters to the needs of non-kernel-based networking use cases is disclosed herein. Unlike prior art monolithic networking stacks, the exemplary networking stack architecture described hereinafter includes various components that span multiple domains (both in-kernel, and non-kernel), with varying transport compositions, workload characteristics and parameters.

The user space networking stack architecture provides an efficient infrastructure to transfer data across domains (user space, non-kernel, and kernel). Unlike the traditional networking paradigm that hides the underlying networking tasks within the kernel and substantially limits control thereof by any non-kernel applications, the various embodiments described herein enable faster and more efficient cross domain data transfers.

Various embodiments of the present disclosure provide a faster and more efficient packet input/output (I/O) infrastructure than prior art techniques. Specifically, unlike traditional networking stacks that use a “socket” based communication, disclosed embodiments can transfer data directly between the kernel and user space domains. Direct transfer reduces the per-byte and per-packet costs relative to socket-based communication. Additionally, direct transfer can improve observability and accountability with traffic monitoring.

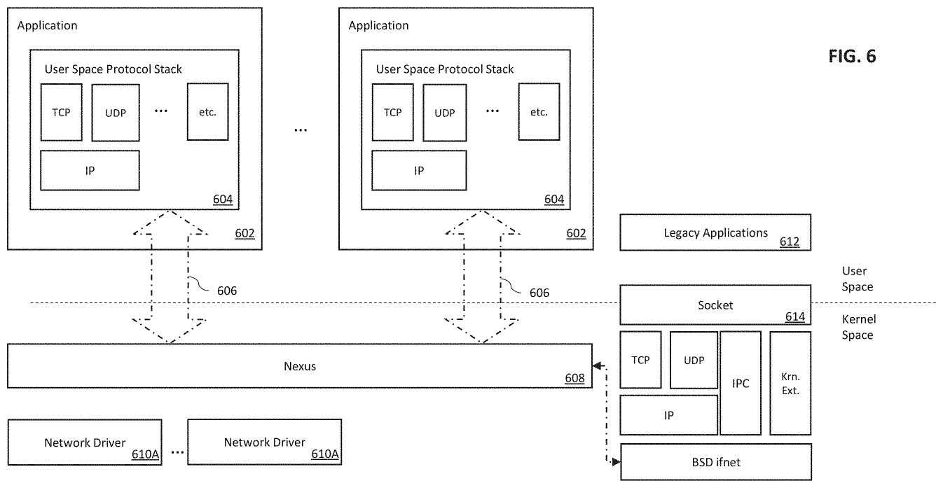

FIG. 6 illustrates one logical representation of an exemplary user space networking stack architecture, in accordance with the various aspects of the present disclosure. While the system depicts a plurality of user space applications 602 and/or legacy applications 612, artisans of ordinary skill will readily appreciate given the contents of present disclosure that the disclosed embodiments may be used within single application systems with equivalent success.

As shown, a user space application 602 can initiate a network connection by instancing user space protocol stacks 604. Each user space protocol stacks includes network extensions for e.g., TCP/UDP/QUIC/IP, cryptography, framing, multiplexing, tunneling, and/or any number of other networking stack functionalities. Each user space protocol stack 604 communicates with one or more nexuses 608 via a channel input/output (I/O) 606. Each nexus 608 manages access to the network drivers 610. Additionally, shown is legacy application 612 support via existing network socket technologies 614. While the illustrated embodiment shows nexus connections to both user space and in-kernel networking stacks, it is appreciated that the nexus may also enable e.g., non-kernel networking stacks (such as may be used by a daemon or other non-kernel, non-user process).

The following topical sections hereinafter describe the salient features of the various logical constructs in greater detail.

### Exemplary User Space I/O Infrastructure

In one embodiment, the non-kernel networking stack provides a direct channel input output (I/O) 606. In one such implementation, the channel I/O 606 is included as part of the user space protocol stack 604. More directly, the channel I/O 606 enables the delivery of packets as a raw data I/O into kernel space with a single validation (e.g., only when the user stack provides the data to the one or more nexuses 608). The data can be directly accessed and/or manipulated in situ, the data need not be copied to an intermediary buffer.

In one exemplary implementation, a channel is an I/O scheme leveraging kernel-managed shared memory. During an access, the channel I/O is presented to the process (e.g., the user process or kernel process) as a file descriptor-based object, rather than as data. In order to access the data, the process de-references the file descriptor for direct access to the shared memory within kernel space. In one such implementation, the file descriptor-based object based I/O is compatible with existing operating system signaling and “eventing” (event notification/response) mechanisms. In one exemplary variant, the channel I/O is based on Inter Process Communication (IPC) packets.

As used herein, the term “descriptor” may refer to data structures that indicate how other data is stored. Descriptors generally include multiple parameters and can be used to identify more complex data structures; for example, a descriptor may include one or more of type, size, address, tag, flag, headers, footers, metadata, structural links to other data descriptors or locations, and/or any other number of format or construction information.

Within the context of the present disclosure, as used herein, the term “pointer” may refer to a specific reference data type that “points” or “references” a location of data in memory. Typically, a pointer stores a memory address that is interpreted by a compiler as an absolute location in system memory or a relative location in system memory based on e.g., a base address, reference address, memory window, or other memory subset. During operation, a pointer is “de-referenced” to recover the data that is stored in the location of memory.

As used herein, the term “metadata” refers to data that describes data. Metadata varies widely in application, but generally falls into one of the descriptive, structural, and/or administrative categories. Descriptive metadata describes data in a manner to enable e.g., discovery and/or identification. Common examples include without limitation e.g., type, size, index tags, and keywords. Structural metadata describes the structure of the data e.g., how compound objects are put together. Common examples include without limitation e.g., prefix, postfix, table of contents, order, and/or any other information that describes the relationships and other characteristics of digital materials. Administrative metadata provides information to help manage a resource; common examples include e.g., authorship and creation information, access privileges, and/or error checking and security-based information (e.g., cyclic redundancy checks (CRC), parity, etc.).

In one embodiment, the channel I/O can be further leveraged to provide direct monitoring of its corresponding associated memory. More directly, unlike existing data transfers which are based on mbuf based divide/copy/move, etc., the channel I/O can provide (with appropriate viewing privileges) a direct window into the memory accesses of the system. Such implementations further simplify software development as debugging and/or traffic monitoring can be performed directly on traffic. Direct traffic monitoring can reduce errors attributed to false positives/false negatives caused by e.g., different software versioning, task scheduling, compiler settings, and/or other software introduced inaccuracies.

In one embodiment, the in-kernel network device drivers (e.g. Wi-Fi, Cellular, Ethernet) use simplified data movement models based on the aforementioned channel I/O scheme. More directly, the user space networking stacks can directly interface to each of the various different technology-based network drivers via channel I/O; in this manner, the user space networking stacks do not incur the traditional data mbuf based divide/copy/move penalties. Additionally, user space applications can directly access user space networking components for immediate traffic handling and processing.

### Exemplary Nexus

In one embodiment, the networking stack connects to one or more nexus 608. In one such implementation, the nexus 608 is a kernel space process that arbitrates access to system resources including, without limitation e.g., shared memory within kernel space, network drivers, and/or other kernel or user processes. In one such variant, the nexus 608 aggregates one or more channels 606 together for access to the network drivers 610 and/or shared kernel space memory.

In one exemplary implementation, a nexus is a kernel process that determines the format and/or parameters of the data flowing through its connected channels. In some variants, the nexus may further perform ingress and/or egress filtering.

The nexus may use the determined format and/or parameter information to facilitate one-to-one and one-to-many topologies. For example, the nexus can create user-pipes for process-to-process channels; kernel-pipes for process-to-kernel channels; network interfaces for direct channel connection from a process to in-kernel network drivers, or legacy networking stack interfaces; and/or flow-switches for multiplexing flows across channels (e.g., switching a flow from one channel to one or more other channels).

Additionally, in some variants the nexus may provide the format, parameter, and/or ingress egress information to kernel processes and/or one or more appropriately privileged user space processes.

In one embodiment, the nexus 608 may additionally ensure that there is fairness and/or appropriately prioritize each of its connected stacks. For example, within the context of FIG. 6, the nexus 608 balances the network priorities of both the existing user space application networking stacks 604, as well as providing fair access for legacy socket-based access 614. For example, as previously alluded to, existing networking stacks could starve user space applications because the kernel threads handling the legacy networking stack operated at higher priorities than user space applications. However, the exemplary nexus 608 ensures that legacy applications do not monopolize system resources by appropriately servicing the user space network stacks as well as the legacy network stack.

In one such embodiment, in-kernel, non-kernel, and/or user space infrastructures ensure fairness and can reduce latency due to e.g., buffer bloat (across channels in a given nexus, as well as flows within a channel). In other words, the in-kernel and/or user space infrastructures can negotiate proper buffering sizes based on the expected amount of traffic and/or network capabilities for each flow. By buffering data according to traffic and/or network capability, buffers are not undersized or oversized.

As a brief aside, “buffer bloat” is commonly used to describe e.g., high latency caused by excessive buffering of packets. Specifically, buffer bloat may occur when excessively large buffers are used to support a real time streaming application. As a brief aside, TCP retransmission mechanism relies on measuring the occurrence of packet drops to determine the available bandwidth. Under certain congestion conditions, excessively large buffers can prevent the TCP feedback mechanism from correctly inferring the presence of a network congestion event in a timely manner (the buffered packets “hide” the congestion, since they are not dropped). Consequently, the buffers have to drain before TCP congestion control resets and the TCP connection can correct itself.

Referring back to FIG. 6, in one embodiment, Active Queue Management (AQM) can be implemented in the kernel across one or more (potentially all) of the flow-switch clients (user space and in-kernel networking stack instances). AQM refers to the intelligent culling of network packets associated with a network interface, to reduce network congestion. By dropping packets before the queue is full, the AQM ensures no single buffer approaches its maximum size, and TCP feedback mechanisms remain timely (thereby avoiding the aforementioned buffer bloat issues).

While the foregoing example is based on “fairness” standard, artisans of ordinary skill in the related arts will readily appreciate that other schemes may be substituted with equivalent success given the contents of the present disclosure. For example, some embodiments may dynamically or statically service the user application networking space with greater or less weight compared to the legacy socket-based access. For example, user application networking space may be more heavily weighted to improve overall performance or functionality, whereas legacy socket-based access may be preferred where legacy applications are preferentially supported.

### Exemplary Network Extensions

In one embodiment of the present disclosure, a network extension is disclosed. A network extension is an agent-based extension that is tightly coupled to network control policies. The agent is executed by the kernel and exposes libraries of network control functionality to user space applications. During operation, user space software can access kernel space functionality through the context and privileges of the agent.

As used herein, the term “agent” may refer to a software agent that acts for a user space application or other program in a relationship of agency with appropriate privileges. The agency relationship between the agent and the user space application implies the authority to decide which, if any, action is appropriate given the user application and kernel privileges. A software agent is privileged to negotiate with the kernel and other software agents regarding without limitation e.g., scheduling, priority, collaboration, visibility, and/other sharing of user space and kernel space information. While the agent negotiates with the kernel on behalf of the application, the kernel ultimately decides on scheduling, priority, etc.

Various benefits and efficiencies can be gained through the use of network extensions. In particular, user space applications can control the protocol stack down to the resolution of exposed threads (i.e., the threads that are made available by the agent). In other words, software agents expose specific access to lower layer network functionality which was previously hidden or abstracted away from user space applications. For example, consider the previous examples of TLS record sizing (see e.g., FIG. 3, and related discussion); by exposing TCP network conditions to the TLS application within the user space, the TLS application can correctly size records for network congestion and/or wait for underlying TCP retransmissions (rather than timing out).

Similarly, consider the previous examples of multi-threading within the context of expected use devices (see e.g., FIG. 5, and related discussion); the primary user space application (e.g., video coding) and additional secondary interactive applications (e.g., remote control interface, headphones, and/or other interface devices) can internally negotiate their relative priority to the user's experience. The user space applications can appropriately adjust their priorities for the nexus (i.e., which networking threads are serviced first and/or should be deprioritized). Consequently, the user space applications can deprioritize non-essential network accesses, thereby preserving enough CPU cycles for video decode.

As a related benefit, since a software agent represents the application to the kernel; the agent can trust the kernel, but the kernel may or may not trust the agent. For example, a software agent can be used by the kernel to convey network congestion information in a trusted manner to the application; similarly, a software agent can be used by an application to request a higher network priority. Notably, since a software agent operates from user space, the agent's privilege is not promoted to kernel level permissions. In other words, the agent does not permit the user application to exceed its privileges (e.g., the agent cannot commandeer the network driver at the highest network priority or force a read/write to another application's memory space without the other kernel and/or other application's consent).

Networking extensions allow the user space application to execute networking communications functionality within the user space and interpose a network extension between the user space application and the kernel space. As a result, the number of cross domain accesses for complex layering of different protocol stacks can be greatly reduced. Limiting cross domain accesses prevents context switching and allows the user space to efficiently police its own priorities. For example, consider the previous example of a VPN session as was previously illustrated in FIG. 4. By keeping the TCP/IP, Internet Protocol Security (IPsec) and TLS operations within user space, the entire tunnel can be performed within the user space, and only cross the user/kernel domain once.

As used herein, the term “interposition” may refer to the insertion of an entity between two or more layers. For example, an agent is interposed between the application and the user space networking stack. Depending on the type of agent or network extension, the interposition can be explicit or implicit. Explicit interposition occurs where the application explicitly instances the agent or network extension. For example, the application may explicitly call a user space tunnel extension. In contrast, implicit interposition occurs where the application did not explicitly instance the agent or network extension. Common examples of implicit interposition occur where one user space application sniffs the traffic or filters the content of another user space application.

As used herein, an “instance” may refer to a single copy of a software program or other software object; “instancing” and “instantiations” refers to the creation of the instance. Multiple instances of a program can be created; e.g., copied into memory several times. Software object instances are instantiations of a class; for example, a first software agent and second software instance are each distinct instances of the software agent class.

### Exemplary User Space Networking Stack

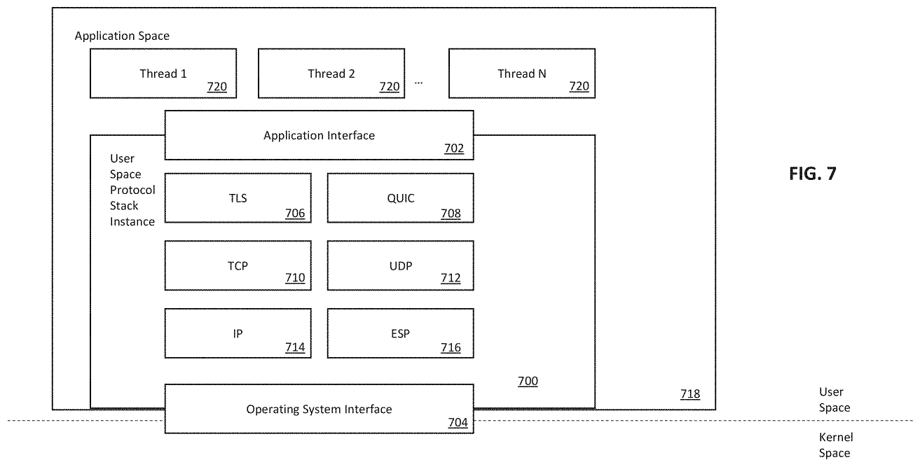

Referring now to FIG. 7, one logical block diagram of an exemplary user space networking stack 700 is depicted. As shown, the user space networking stack 700 includes an application interface 702, and an operating system interface 704. Additionally, the user space networking stack includes one or more user space instances of TLS 706, QUIC 708, TCP 710, UDP 712, IP 714, and ESP 716. The disclosed instances are purely illustrative, artisans of ordinary skill in the related arts will readily appreciate that any other user space kernel extension and/or socket functionality may be made available within the user space networking stack 700.

In one exemplary embodiment, the user space networking stack 700 is instantiated within an application user space 718. More directly, the user space networking stack 700 is treated identically to any one of multiple threads 710 within the application user space 718. Each of the coexisting threads 720 has access to the various functions and libraries offered by the user space networking stack via a direct function call.

As a brief aside, each of the threads 720 reside within the same address space. By virtue of their shared addressability, each of the threads may grant or deny access to their portions of shared address space via existing user space memory management schemes and/or virtual machine type protections. Additionally, threads can freely transfer data structures from one to the other, without e.g., incurring cross domain penalties. For example, TCP data 710 can be freely passed to TLS 706 as a data structure within a user space function call.

As previously noted, the user space networking stack 700 may grant or deny access to other coexistent user space threads; e.g., a user space thread is restricted to the specific function calls and privileges made available via the application interface 702. Furthermore, the user space networking stack 700 is further restricted to interfacing the operating system via the specific kernel function calls and privileges made available via the operating system interface 704. In this manner, both the threads and the user space networking stack have access and visibility into the kernel space, without compromising the kernel's security and stability.

One significant benefit of the user space networking stack 700 is that networking function calls can be made without acquiring various locks that are present in the in-kernel networking stack. As previously noted, the “locking” mechanism is used by the kernel to enforce access limits on multiple threads from multiple different user space applications; however in the user space, access to shared resources are handled within the context of only one user application space at a time, consequently access to shared resources are inherently handled by the single threading nature of user space execution. More directly, only one thread can access the user space networking stack 700 at a time; consequently, kernel locking is entirely obviated by the user space networking stack.

Another benefit of user space network stack operation is cross platform compatibility. For example, certain types of applications (e.g., iTunes®, Apple Music® developed by the Assignee hereof) are deployed over a variety of different operating systems. Similarly, some emerging transport protocols (e.g. QUIC) are ideally served by portable and common software between the client and server endpoints. Consistency in the user space software implementation allows for better and more consistent user experience, improves statistical data gathering and analysis, and provides a foundation for enhancing, experimenting and developing network technologies used across such services. In other words, a consistent user space networking stack can be deployed over any operating system platform without regard for the native operating system stack (e.g., which may vary widely).

Another important advantage of the exemplary user space networking stack is the flexibility to extend and improve the core protocol functionalities, and thus deliver specialized stacks based on the application's requirements. For example, a video conferencing application (e.g., FaceTime® developed by the Assignee hereof) may benefit from a networking stack catered to optimize performance for real-time voice and video-streaming traffics (e.g., by allocating more CPU cycles for video rendering, or conversely deprioritizing unimportant ancillary tasks). In one such variant, a specialized stack can be deployed entirely within the user space application, without specialized kernel extensions or changes to the kernel. In this manner, the specialized user space networking stack can be isolated from networking stacks. This is important both from a reliability standpoint (e.g., updated software doesn't affect other software), as well as to minimize debugging and reduce development and test cycle times.

Furthermore, having the network transport layer (e.g. TCP, QUIC) reside in user space can open up many possibilities for improving performance. For example, as previously alluded to, applications (such as TLS) can be modified depending on the underlying network connections. User space applications can be collapsed or tightly integrated into network transports. In some variants, data structure sizes can be adjusted based on immediate lower layer network condition information (e.g., to accommodate or compensate for poor network conditions). Similarly, overly conservative or under conservative transport mechanisms can be avoided (e.g., too much or not enough buffering previously present at the socket layer). Furthermore, unnecessary data copies and/or transforms can be eliminated and protocol signaling (congestion, error, etc.) can be delivered more efficiently.

In yet another embodiment, the exemplary user space networking stack further provides a framework for both networking clients and networking providers. In one such variant, the networking client framework allows the client to interoperate with any network provider (including the legacy BSD stack). In one such variant, the network provider framework provides consistent methods of discovery, connection, and data transfer to networking clients. By providing consistent frameworks for clients and providers which operate seamlessly over a range of different technologies (such as a VPN, Bluetooth, Wi-Fi, cellular, etc.), the client software can be greatly simplified while retaining compatibility with many different technologies.

### Protocol Handshakes and Batch Processing

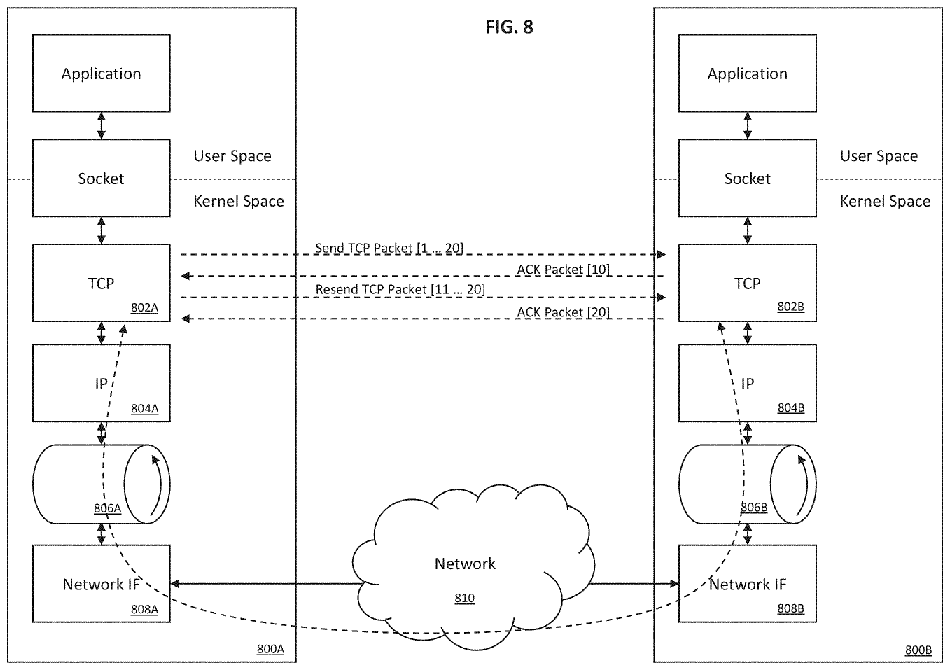

FIG. 8 is a logical block diagram of the Transmission Control Protocol (TCP) acknowledgement and retransmission procedure, useful to illustrate various aspects of the present disclosure. As shown in FIG. 8, two (2) endpoint devices 800A, 800B transact data packets via a communication stack. The communication stack includes: a TCP layer (802A, 802B), IP layer (804A, 804B), buffer (806A, 806B), and a network interface (808A, 808B). The endpoint devices (800A, 800B) are connected to a network 810 which may include multiple intermediary nodes (e.g., peer devices, routers, servers, etc.)

Each layer of the communication stack corresponds to functions that are performed within the hardware, firmware, or software of the endpoint devices 800A, 800B. During operation each layer serves the layer “vertically” above it and is served by the layer “vertically” below it. For example, the IP layer (804A) provides internet connectivity for the TCP layer (802A) above it, and it uses the network interface layer (806A) to send and receive packets. Additionally, each layer communicates with a corresponding peer layer “horizontally” within one or more peer network device(s). For example, TCP layer 802A at a first endpoint device 800A communicates with its peer TCP layer 802B at the second endpoint device 800B.

Consider one illustrative transmission depicted within FIG. 8; as shown therein, the first endpoint 800A sends twenty (20) packets identified by sequential numbers 1 through 20 (TCP Packet [1 . . . 20]). Packets are transmitted from buffer 806A of the first endpoint 800A across the network 810; packets are enqueued into buffer 806B of the second endpoint 800B as they arrive (which may be out-of-order).

The second endpoint 800B performs re-ordering and de-duplication of received packets in its buffer 806B. Packets that are error free and correctly sequenced can be dequeued from the buffer 806B; the data payloads are provided to the destination user space application via the network socket. Out-of-order/errored packets remain in the buffer 806B. In this case, the second endpoint 800B only successfully receives the first ten (10) packets. Responsively, the second endpoint 800B acknowledges the last successfully received packet (ACK packet [10]).

Upon receiving the acknowledgement packet (ACK packet [10]), the first endpoint 800A can infer that all packets up to the acknowledged packet have been correctly received. Successfully received packets are dequeued from the transmit buffer 806A and the remaining packets (TCP Packet [11 . . . 20]) are resent. When the retransmission is successfully received, the second endpoint 800B provides the corresponding acknowledgement packet (ACK packet [20]).

Notably, higher sequence ACK packets supersede earlier ACK packets; specifically, the transmitting node infers that all packets up to the last received ACK packet have been successfully received. In other words, only the most recent ACK packet is necessary; all previous ACK packets provide “stale” transmission status. As a related observation, packets in the buffers 806A, 806B are only dequeued when they have been successfully transferred (error free and in sequence). In order to prevent buffer overflows and/or unnecessary network congestion, certain devices dynamically adjust data transfer rates (“throttle”) based on the most recent ACK status. For example, certain fair queuing algorithms preferentially service connections that show the most favorable bandwidth. Similarly, some algorithms attempt to reduce network congestion by pre-emptively culling data packets; the aforementioned Active Queue Management (AQM) technique is one such example.

As illustrated in the foregoing discussion, the existing TCP acknowledgment and retransmission procedure uses a handshake to guarantee data delivery. IP packets may be lost, duplicated, or delivered out of order due to network congestion, traffic load balancing, or unpredictable network behavior. TCP detects these problems, requests retransmission of lost data, rearranges out-of-order data and helps minimize network congestion to reduce the occurrence of the other problems. If the data still remains undelivered, the source is notified of this failure. Once the TCP receiver has reassembled the data that was originally transmitted, it passes them to the receiving application.

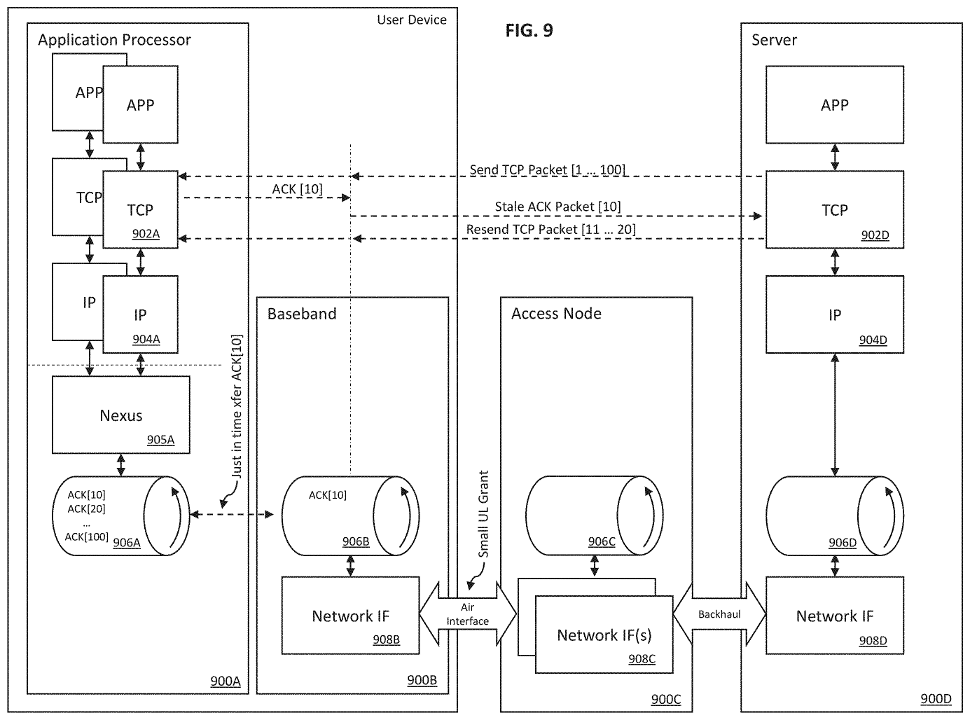

The foregoing discussion of FIG. 8 focused on the protocol transactions between endpoints, however actual implementations may introduce unexpected complications. Referring now to FIG. 9, a logical block diagram of an exemplary system that implements batch processing in conjunction with the aforementioned Transmission Control Protocol (TCP) is presented. As shown, the user device includes an application processor 900A that runs multiple user space communication stacks (e.g., TCP 902A, IP 904A); data traffic from the user space communication stacks is batch processed by a nexus 905A and buffered within a local buffer 906A for transactions with a baseband processor 900B. The baseband processor 900B batch processes data and uses its own local buffer 906B for transactions with the application processor 900A and access node 900C (e.g., base station, access point, network server, etc.) Similarly, the access node 900C and server 900D maintain their own local buffers 906C, 906D.

In the illustrated embodiment, the baseband processor 900B and access node 900C communicate via their respective network interfaces 908B, 908C via an air interface (wireless). Similarly, the access node 900C and server 900D may communicate via their respective network interfaces 908C, 908D via a backhaul interface (wireline). However, different networking technologies have different capabilities. Specifically, wireless communication technologies often asymmetrically distribute resources between uplink and downlink; for example, cellular networks may provide large downlink capacity, but very limited uplink capacity. Similarly, backhaul networks may provide dedicated point-to-point bandwidth for commonly used services; for example, the link between the access node 900C and the server 900D may provide enough bandwidth to service many user devices. Notably, the TCP layer (902A, 902D) and IP layer (904A, 904D) operate at a layer of abstraction above physical communication and are thus cannot distinguish between delays attributed to normal device operation and/or different networks.

Each of the foregoing entities (e.g., application processor 900A, baseband processor 900B, access node 900C, and server 900D) operate according to their own considerations which are distinct from the aforementioned communication protocols. For example, the application processor 900A and baseband processor 900B provide different user functionality and are usually operated independently of one another; e.g., the application processor 900A manages user experience whereas the baseband processor 900B manages network connectivity. Similarly, the access node 900C may service many different user devices, and the server 900D may send and receive data to a number of devices across many different access technologies. Data buffers 906A, 906B, 906C, 906D, independently enqueue and dequeue data according to their respective considerations. In other words, buffering communication between different logical entities of the system ensures that each entity can independently service their buffered data when needed, and move on to address other tasks.

Consider the illustrative transmission depicted within FIG. 9; as shown therein, the server TCP layer 902D has substantial bandwidth availability to the access node 900C; in order to maximize its throughput, it batches a large number of packets for delivery to the user device. In the illustrated example, one hundred (100) packets are batched for delivery to the user device's TCP layer 902A. In this example, all packets are delivered via the backhaul interface and the asymmetric air interface (biased to maximize downlink capacity.) The TCP layer 902A batch processes all one hundred (100) packets and generates regular ACK packets (ACK[10], ACK[20], . . . ACK[100]) to indicate that it is ready to accept more data. The ACK packets are queued for delivery within the application processor's buffer 906A.

Unfortunately, in this scenario, the baseband 908B is only allocated a small uplink grant. The baseband processor 900B reads only the amount of data that can be transmitted in its small grant (also referred to as a “just-in-time transfer”). For instance, in the illustrated embodiment, the baseband 906B only enqueues a stale ACK packet [10]; the “fresh”, most recent, packet ACK [100] is still queued behind other ACK packets of the local buffer 906A.

Upon receiving the stale ACK packet [10], the server's TCP layer 902D incorrectly attributes the low ACK packet as being due to a network condition. Consequently, the server's TCP layer 902D inappropriately responds by greatly reducing service bandwidth and retransmitting data that has already been successfully received (i.e., only ten (10) packets (TCP packets [11 . . . 20]).

As a brief aside, certain baseband processors may attempt to implement heuristics and/or packet inspection logic to “guess” which can ACK packets can be suppressed for a traditional network communication stack. Unfortunately, such baseband processors do not have higher layer protocol information (e.g., TCP connection state), instead they perform packet inspection to extract stateless packet header information and rely on heuristics (e.g., packet sequence number, etc.) in order to identify which ACK packets to send. Even within traditional network communication stacks, ACK suppression in the baseband is undesirable as packet inspection adds processing overhead and heuristics are not always accurate.

As an additional complication, the exemplary user space networking architecture adds complexities that cannot be addressed via stateless ACK suppression techniques. Notably, the exemplary architecture often concurrently runs multiple user space TCP layers with independent TCP connection states via a common network interface. Under such conditions, the baseband processor cannot distinguish between ACK packets of different user space communication stacks; furthermore, since packet sequences are freely intermingled, non-sequential baseband packet inspection and heuristics are useless and must be disabled. Further exacerbating matters, while each user space application stack may have internal ACK suppression logic, they are unaware of other activity. This can create issues where, for example, a user space network stack acknowledges too frequently and prevents other stacks from queuing their acknowledgements.

### Cross-Layer Transport Awareness

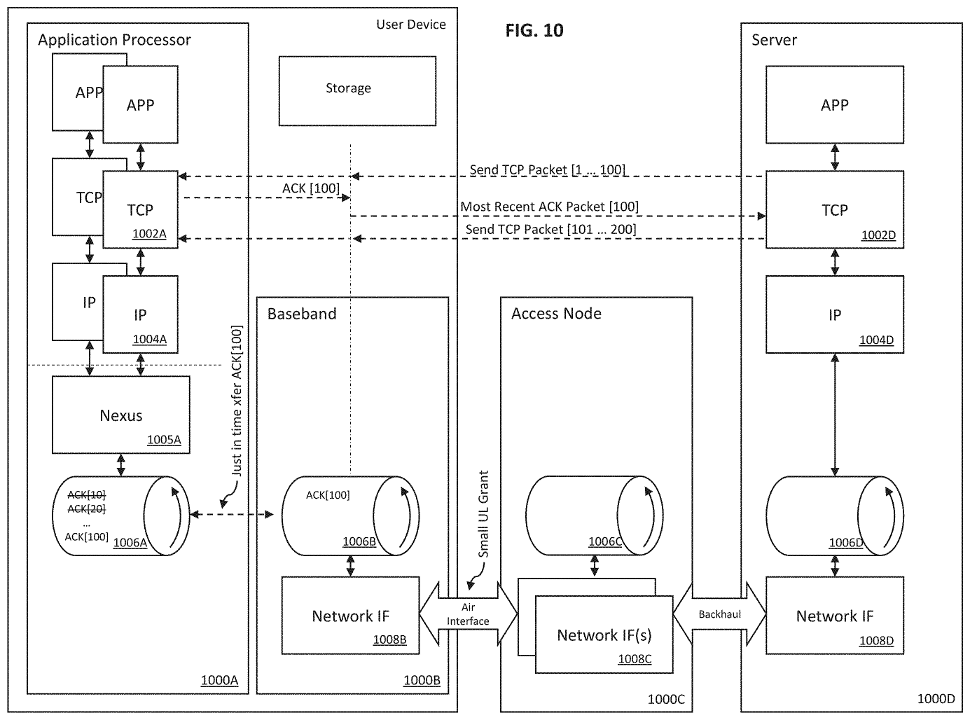

Various embodiments of the present disclosure enable cross-layer transport awareness to coordinate ACK suppression between different layers. The various techniques described herein may coordinate peer layers (horizontal cross-layer communication) and/or hierarchical layers (vertical cross-layer communication). FIG. 10 is a logical block diagram of an exemplary system that implements cross-layer awareness in conjunction with batch processing, in accordance with the various principles described herein.

In one exemplary embodiment, the user device includes an application processor 1000A that has a logical TCP/IP connection to the server 1000D; e.g., between the TCP peer layers (1002A, 1002D) and IP peer layers (1004A, 1004D). Additionally, the user device includes a baseband processor 1000B that physically communicates with an access node 1000C. Each of the logical entities has corresponding buffers (1006A, 1006B, 1006C, 1006D) and network interfaces (1008A, 1008B, 1008C, 1008D) for their respective operations.

During cross-layer transport aware operation, different layers explicitly coordinate acknowledgement signaling. In one embodiment, each user space communication stack of the application processor keeps track of their current connection state and provides explicit indications to the baseband processor that identify their most recent state. For example, the exemplary TCP layer 1002A provides a generation count that indicates whether an ACK packet may supersede a previously issued ACK packet having the same generation count.

In one exemplary embodiment, the application processor's local buffer 1006A is an Active Queue Management (AQM) buffer that normally culls network packets to reduce network congestion. During exemplary operation, the AQM can use the generation count to identify which ACK packets of the currently active network connections are “stale” and can be culled (dequeued without transmission) or are “fresh” and should be provided for just-in-time transfer. Notably, the exemplary generation count also reduces baseband processing complexity and improves accuracy because further ACK suppression is not required (the baseband doesn't need to perform packet inspection (unpacking and parsing header information) and heuristic guessing.)

As depicted within FIG. 10, the server TCP layer 1002D batches and successfully delivers one hundred (100) packets to the user device's TCP layer 1002A. As before, the TCP layer 1002A batch processes all one hundred (100) packets and generates regular ACK packets (ACK[10], ACK[20], . . . ACK[100]) to indicate that it is ready to accept more data. Additionally, each ACK packet is associated with a generation count for the specific data flow. The generation count identifies ACK packets that can be compressed together. Specifically, recent ACK packets supersede all previous ACK packets having the same generation count (for the same packet flow). Notably, certain ACKs cannot be culled; for example, some ACK packets may require special handling. Similarly, some ACKs may be left in for other reasons, even though they could be culled. For example, packet culling may implement rate limiting behavior to ensure that ACK packets are not too frequent (e.g., no less than 1 ms), nor too infrequent (e.g., no more than 5 ms). Rate limiting behavior may be necessary to ensure that network connections remain active and/or do not crowd out other network activity.

During operation, the application processor's Active Queue Management (AQM) buffer 1006A continually culls stale ACK packets based on generation counts. Thus, only the most recent/necessary ACKs for each data flow are present in the AQM 1006A. The baseband 908B queues data packets for just-in-time transfer, including the most recent ACK packet [100] for the flow. Upon receiving the most recent ACK packet [100], the server's TCP layer 1002D responds by maintaining service bandwidth and transmitting new (i.e., one hundred (100) packets (TCP packets [101 . . . 200]).

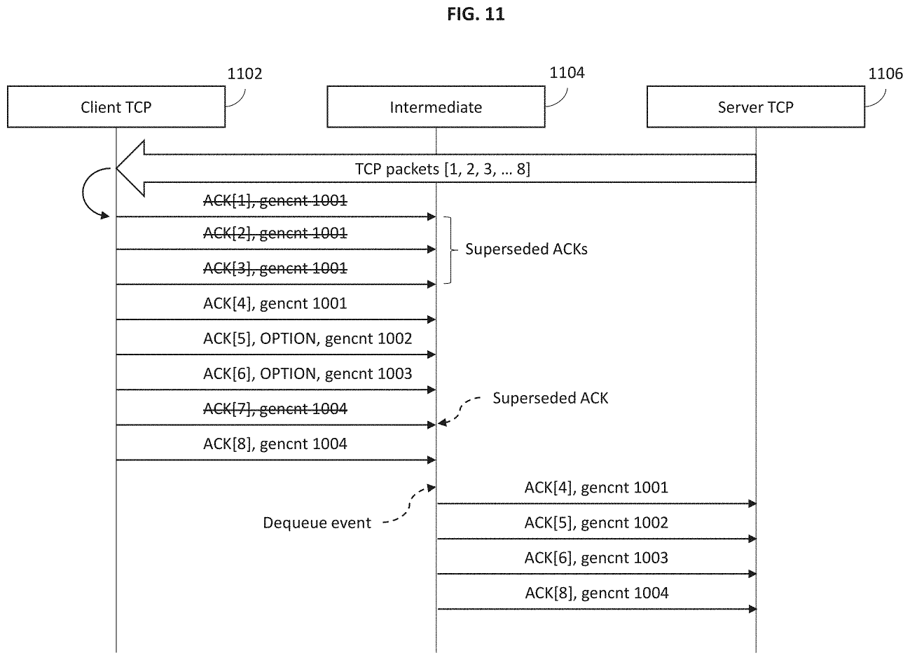

FIG. 11 is a logical ladder diagram representation of one exemplary Transmission Control Protocol (TCP) Acknowledgement (ACK) suppression scheme, in accordance with the various principles described herein. In the illustrated scenario, a server TCP layer 1106 transmits TCP packets which causes a client TCP layer 1102 to generate corresponding ACK packets. The client TCP layer 1102 provides the ACK packets to an intermediate node 1104 for delivery. The intermediate node 1104 holds ACK packets within a queue until a dequeue event (e.g., a resource grant, network availability, etc.)

In one exemplary embodiment, the client and server TCP layers 1102, 1106 manage TCP connection state for each packet flow, and can communicate this information to other layers via cross-layer signaling. As shown, the client TCP layer 1102 identifies ACK packets that supersede any previous ACK packets of the same packet flow via a generation count (gencnt). Specifically, ACK packets overwrite earlier ACKs with the same generation count. For example, ACK[1, 2, 3] (corresponding to a first flow) may be superseded by ACK[4], and ACK[7] (corresponding to a second flow) may be superseded by ACK[8]. Certain ACK packets may not be culled; for example, ACK[5] and ACK[6] may include special TCP signaling that must be delivered. At the dequeue event, the intermediate entity 1104 (e.g., an Active Queue Management (AQM) buffer, baseband processor, or other entity) only delivers the most recent/necessary ACK packets having unique gencnt identifiers.

More generally, the exemplary mechanisms described herein identify the necessary/most recent ACK packets in a flow-specific manner, such that non-TCP entities can cull packets without tracking TCP state information, heuristics, or deep packet inspection, etc. While the illustrative example uses a generation count, other mechanisms may be substituted by artisans of ordinary skill given the contents of the present disclosure. Examples of other possible variants include, without limitation e.g., flow-specific decrementing counters, flow-specific tags, flow-specific timestamps, and/or any other such indication.

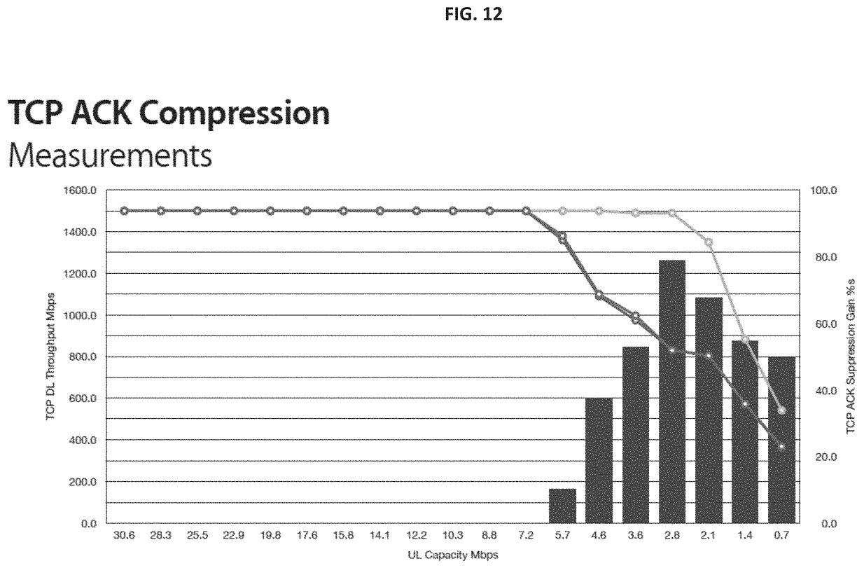

FIG. 12 is a graphical representation of network performance, useful to illustrate the various advantages of the present disclosure. As shown therein, empirical data suggests that TCP downlink rates are throttled down when uplink capacity drops below 7.2 Mbps without ACK suppression because stale ACK packets crowd out recent ACK packets. In contrast, operating with ACK suppression delivers the most recent ACK packets. Network servers preserve downlink capacity until uplink capacity drops below 2.8 Mbps.

While the foregoing operation is presented in the context of an endpoint application, the various techniques described herein may be used by any buffer of the system. More generally, as described in greater detail herein, explicit coordination signaling (e.g., generation count, etc.) may be used by any layer, of any entity, to reduce stale ACK signaling.

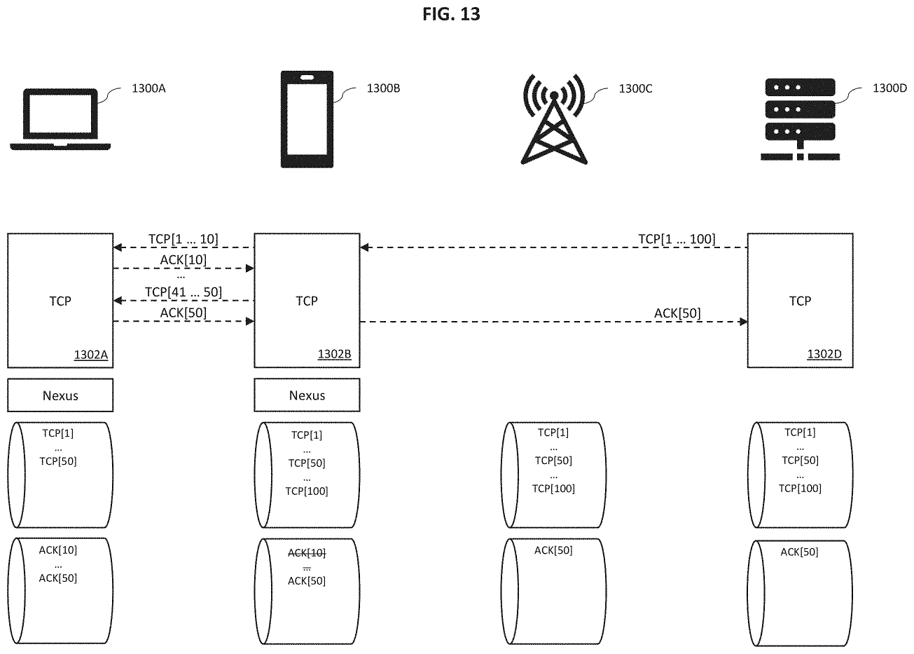

FIG. 13 is a logical block diagram of a network of devices useful to describe pass through cross-layer signaling, in accordance with various aspects of the present disclosure. As shown therein, a laptop 1300A running a first TCP layer 1302A is tethered to a cellular device 1300B running a second TCP layer 1302B. The cellular device provides network connectivity via an access node 1300C, to a server 1300D running a third TCP layer 1302D.

As previously noted, different networking technologies have different capabilities; for example, cellular networking may enable long distance communication whereas wireless local area networking may offer much higher throughput and lower latency over short distances. In the illustrated example, the laptop 1300A and cellular device 1300B have ample bandwidth via a wireless local area network; consequently, data packets and ACKs may be sent frequently. In contrast, the cellular device 1300B and access node 1300C operate over a cellular link characterized by high throughput and high latency; acknowledgements are sent relatively infrequently.

In the illustrated embodiment, the server TCP layer 1302D delivers one hundred (100) packets to the cellular device's TCP layer 1302B. The cellular device relays the packets to the laptop, and the TCP layer 1302A processes packets and generates corresponding ACK packets and generation count indications. However, only fifty (50) of the packets have been successfully delivered by the time the cellular network grants new uplink resources to the cellular device. Responsively, the cellular device reviews the generation count indications for each ACK packet, and culls stale ACK packets (ACK [10]. . . , etc.) In this manner, the cellular device delivers only the necessary/most recent acknowledgment (ACK[50]). As each node acknowledges successful delivery, the data packets can be dequeued from their corresponding buffers.

As demonstrated within FIG. 13, the acknowledgment packets are passed along with their corresponding generation indication through the network. In this manner, “pass through” cross-layer communication can allow any intermediate node to cull stale acknowledgement packets. More generally, complex networks often accumulate queues at multiple locations (any node that batches operations may create a queue when the ingress of data exceeds the egress data). Explicit indications can be passed throughout the network such that any node may optimize their available capacity to maximize transfers of queued data.

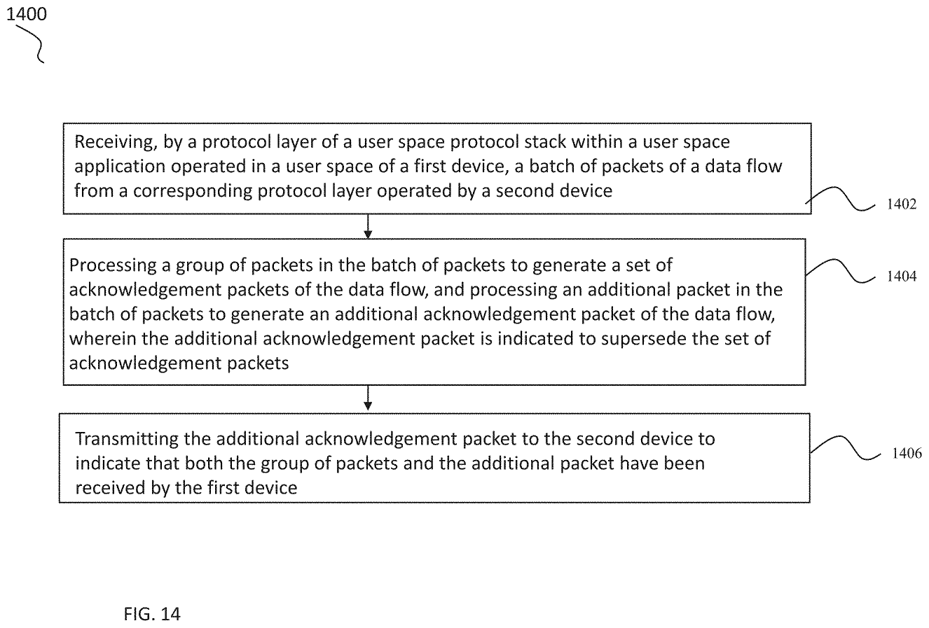

FIG. 14 is a logical diagram representation of one exemplary acknowledgement suppression scheme 1400, in accordance with the various principles described herein. Acknowledgement suppression scheme 1400 can be an example of the TCP ACK suppression scheme illustrated in FIG. 10-11.

At 1402, a protocol layer of a user space protocol stack within a user space application operated in a user space of a first device can receive a batch of packets of a data flow from a corresponding protocol layer operated by a second device.

At 1404, the protocol layer of a user space protocol stack can process a group of packets in the batch of packets to generate a set of acknowledgement packets of the data flow, and further process an additional packet in the batch of packets to generate an additional acknowledgement packet of the data flow. The additional acknowledgement packet is indicated to supersede the set of acknowledgement packets.

At 1406, the protocol layer of a user space protocol stack can transmit the additional acknowledgement packet to the second device to indicate that both the group of packets and the additional packet have been received by the first device.

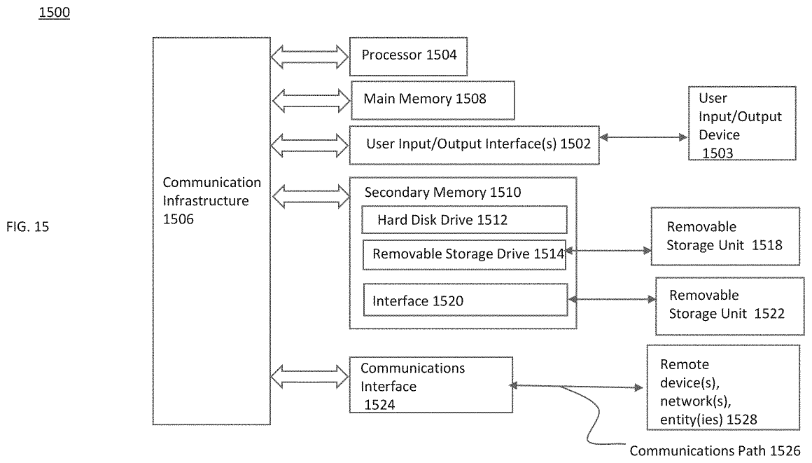

Various embodiments can be implemented, for example, using one or more computer systems, such as computer system 1500 shown in FIG. 15. Computer system 1500 can be used, for example, to implement processes of FIG. 14. For example, computer system 1500 can implement and execute a set of instructions comprising operations for cross-layer awareness in conjunction with batch processing, Transmission Control Protocol (TCP) Acknowledgement (ACK) suppression schemes, pass through cross-layer signaling, as illustrated in FIGS. 1-14. Computer system 1500 can be any computer capable of performing the functions described herein.

Computer system 1500 includes one or more processors (also called central processing units, or CPUs), such as a processor 1504. Processor 1504 is connected to communication infrastructure or bus 1506.

One or more processors 1504 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1500 also includes user input/output device(s) 1503, such as monitors, keyboards, pointing devices, etc., that communicate with communication infrastructure 1506 through user input/output interface(s) 1502.

Computer system 1500 also includes a main or primary memory 1508, such as random access memory (RAM). Main memory 1508 may include one or more levels of cache. Main memory 1508 has stored therein control logic (i.e., computer software) and/or data.

Computer system 1500 may also include one or more secondary storage devices or memory 1510. Secondary memory 1510 may include, for example, a hard disk drive 1512 and/or a removable storage device or drive 1514. Removable storage drive 1514 may be a floppy disk drive, a magnetic tape drive, a compact disk drive, an optical storage device, tape backup device, and/or any other storage device/drive.

Removable storage drive 1514 may interact with a removable storage unit 1518. Removable storage unit 1518 includes a computer usable or readable storage device having stored thereon computer software (control logic) and/or data. Removable storage unit 1518 may be a floppy disk, magnetic tape, compact disk, DVD, optical storage disk, and/any other computer data storage device. Removable storage drive 1514 reads from and/or writes to removable storage unit 1518 in a well-known manner.

According to an exemplary embodiment, secondary memory 1510 may include other means, instrumentalities or other approaches for allowing computer programs and/or other instructions and/or data to be accessed by computer system 1500. Such means, instrumentalities or other approaches may include, for example, a removable storage unit 1522 and an interface 1520. Examples of the removable storage unit 1522 and the interface 1520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1500 may further include a communication or network interface 1524. Communication interface 1524 enables computer system 1500 to communicate and interact with any combination of remote devices, remote networks, remote entities, etc. (individually and collectively referenced by reference number 1528). For example, communication interface 1524 may allow computer system 1500 to communicate with remote devices 1528 over communications path 1526, which may be wired and/or wireless, and which may include any combination of LANs, WANs, the Internet, etc. Control logic and/or data may be transmitted to and from computer system 1500 via communication path 1526.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 1500, main memory 1508, secondary memory 1510, and removable storage units 1518 and 1522, as well as tangible articles of manufacture embodying any combination of the foregoing. Such control logic, when executed by one or more data processing devices (such as computer system 1500), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 15. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

It will be recognized that while certain embodiments of the present disclosure are described in terms of a specific sequence of steps of a method, these descriptions are only illustrative of the broader methods described herein, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure and claimed herein.

While the above detailed description has shown, described, and pointed out novel features as applied to various embodiments, it will be understood that various omissions, substitutions, and changes in the form and details of the device or process illustrated may be made by those skilled in the art without departing from principles described herein. The foregoing description is of the best mode presently contemplated. This description is in no way meant to be limiting, but rather should be taken as illustrative of the general principles described herein. The scope of the disclosure should be determined with reference to the claims.

What is claimed is:

1. A method, comprising:
receiving, by a protocol layer of a user space protocol stack within a user space application operated in a user space of a first device, a batch of packets of a data flow from a corresponding protocol layer operated by a second device;
processing a group of packets in the batch of packets to generate a set of acknowledgement packets of the data flow, and processing an additional packet in the batch of packets to generate an additional acknowledgement packet of the data flow, wherein the additional acknowledgement packet is indicated to supersede the set of acknowledgement packets; and
transmitting the additional acknowledgement packet to the second device to indicate that both the group of packets and the additional packet have been received by the first device.

2. The method of claim 1, further comprising:
discarding the set of acknowledgement packets without transmitting the set of acknowledgement packets to the second device.

3. The method of claim 1, wherein the additional acknowledgement packet is associated with a generation count to identify the data flow, and the set of acknowledgement packets is associated with the same generation count to identify the data flow.

4. The method of claim 1, wherein the protocol layer of the user space protocol stack within the user space application is a transport layer (TCP) protocol.

5. The method of claim 1, wherein the additional packet is identified by a packet sequential number that is larger than corresponding packet sequential numbers that identify the group of packets.

6. The method of claim 1, wherein the group of packets is a first group of packets in the batch of packets, the set of acknowledgement packets is a first set of acknowledgement packets, and the additional packet is included in a second group of packets in the batch of packets, and the method further comprises:
processing the second group of packets to generate a second set of acknowledgement packets including the additional acknowledgement packet, wherein the second set of acknowledgement packets is indicated to supersede the first set of acknowledgement packets; and
transmitting the second set of acknowledgement packets to the second device to indicate that both the first group of packets and the second group of packets have been received by the first device.

7. The method of claim 1, wherein the transmitting the additional acknowledgement packet includes transmitting the additional acknowledgement packet vertically across one or more protocol layers of the user space protocol stack to a queue manager of a buffer of the first device, and the method further comprising:
discarding, by the queue manager of the buffer, the set of acknowledgement packets; and
transmitting, by the queue manager of the buffer, the additional acknowledgement packet to the second device.

8. The method of claim 7, wherein the buffer is coupled to the user space protocol stack through a nexus at a kernel space.

9. The method of claim 1, wherein the transmitting the additional acknowledgement packet to the second device includes transmitting the additional acknowledgement packet horizontally to a corresponding protocol layer of an intermediate device between the first device and the second device, wherein the additional acknowledgement packet is to be transmitted to the second device by the intermediate device to indicate that both the group of packets and the additional packet have been received by the first device.

10. A system configured for managing packet flows, the system comprising:
a storage device; and
a processor coupled to the storage device, and configured to:
receive, by a protocol layer of a user space protocol stack within a user space application operated in a user space of a first device, a batch of packets of a data flow from a corresponding protocol layer operated by a second device;
process a group of packets in the batch of packets to generate a set of acknowledgement packets of the data flow, and process an additional packet in the batch of packets to generate an additional acknowledgement packet of the data flow, wherein the additional acknowledgement packet is indicated to supersede the set of acknowledgement packets; and
transmit the additional acknowledgement packet to the second device to indicate that both the first group of packets and the additional packet have been received by the first device.

11. The system of claim 10, wherein the processor is further configured to:
discard the set of acknowledgement packets without transmitting the set of acknowledgement packets to the second device.

12. The system of claim 10, wherein the additional acknowledgement packet is associated with a generation count to identify the data flow, and the set of acknowledgement packets is associated with the same generation count to identify the data flow.

13. The system of claim 10, wherein the protocol layer of the user space protocol stack within the user space application is a transport layer (TCP) protocol.

14. The system of claim 10, wherein the additional packet is identified by a packet sequential number that is larger than corresponding packet sequential numbers that identify the group of packets.

15. The system of claim 10, wherein the group of packets is a first group of packets in the batch of packets, the set of acknowledgement packets is a first set of acknowledgement packets, the additional packet is included in a second group of packets in the batch of packets, and the processor is further configured to:
process the second group of packets to generate a second set of acknowledgement packets including the additional acknowledgement packet, wherein the second set of acknowledgement packets is indicated to supersede the first set of acknowledgement packets; and
transmit the second set of acknowledgement packets to the second device to indicate that both the first group of packets and the second group of packets have been received by the first device.

16. The system of claim 10, wherein the storage device includes a buffer, and the system further comprises a queue manager of the buffer, wherein the queue manager is configured to:
discard the set of acknowledgement packets without transmitting the set of acknowledgement packets to the second device; and
transmit the additional acknowledgement packet to the second device.

17. The system of claim 16, further comprising:
a nexus at a kernel space, wherein the buffer is coupled to the user space protocol stack through the nexus.

18. The system of claim 16, wherein the processor is further configured to transmit the additional acknowledgement packet vertically across one or more protocol layers of the user space protocol stack to the queue manager.

19. A non-transitory computer readable medium comprising computer instructions stored thereon, the computer programs being configured to, when executed by a processor, cause a computerized apparatus to:
receive, by a protocol layer of a user space protocol stack within a user space application operated in a user space of a first device, a batch of packets of a data flow from a corresponding protocol layer operated by a second device;
process a group of packets in the batch of packets to generate a set of acknowledgement packets of the data flow, and process an additional packet in the batch of packets to generate an additional acknowledgement packet of the data flow, wherein the additional acknowledgement packet is indicated to supersede the set of acknowledgement packets; and
transmit the additional acknowledgement packet to the second device to indicate that both the first group of packets and the additional packet have been received by the first device.

20. The non-transitory computer readable medium of claim 19, wherein the computer instructions are configured to further cause the computerized apparatus to discard the set of acknowledgement packets without transmitting the set of acknowledgement packets to the second device.
